(19) United States
(12) Patent Application Publication
(10) Pub. No.: US 2010/0017821 A1
(43) Pub. Date: Jan. 21, 2010

(54) Software based Internet/Television convergence methods and systems for organizing and displaying Internet media content on computers and Television sets

(76) Inventors: Andrei A. Leonov, Tampa, FL (US); Leonard Bensonoff, Tampa, FL (US)

Correspondence Address: Andrei A. Leonov, 903 Mooring Circle, Tampa, FL, 33602, US

(21) Appl. No.: 12/176,702

(22) Filed: Jul. 21, 2008

(51) Int. Cl. G06F 13/00; H04N 7/173

(52) U.S. Cl. 725/37; 725/110

(57) ABSTRACT

Convergence systems described in the prior art typically focus on advancing hardware architecture. Such systems provide limited solutions as consumers are restricted to the use of proprietary networks, incur significant extra costs upgrading their equipment and pay subscription fees. General public demands low cost solutions for the consumption of the Internet media content in a traditional TV watching experience in the living room.

The present invention provides a software-based solution and includes methods, systems, and software codes for a cost effective delivery and organization of multimedia content, informational feeds and interactive advertisements transmitted over the Internet to the user's TV and/or entertainment system already present in the user's home or office.

This invention will further advance the convergence of the Internet, portable screen-based media devices, land line and mobile telephones, and traditional television communication channels. Media content will freely migrate from infinite number of providers/multi-platform environment per consumers' demand, anytime and anywhere.

A software program installed on a computer allows users to select from a list of channels obtained from an Internet database. The system accesses the corresponding URL of media content via the Internet. A separate URL is accessed at the same time as the main broadcast with each channel's program information which can be displayed on demand. The system sends the output to the user's AV system. A computer keyboard or a wireless remote control can be used to navigate channels and perform interactive functions of the user interface. Users can select different geographical areas to access local TV channels and radio stations. All channels have a designated alpha-numeric channel ID. Clickable images, video, captions, scrolling ticker or other content which may represent informational feeds or advertisements can be displayed on the screen at any time based on the information obtained from a remote URL. Statistics and user feedback can be sent to a remote URL.

### TECHNICAL FIELD OF THE INVENTION

The present invention relates to the field of the convergence of the multimedia content delivered to the consumer via TV and the Internet. In particular, this invention provides a software-based plug-and-play remote controlled media processing system and methods of configuring available consumer electronic equipment, which allow the user to access, organize and consume media originating from the Internet in a traditional TV watching environment.

The system is activated and operated by proprietary software, server side and client side. The user can install his software from a CD or download it via the Internet. The client side software provides direct access to content on the Internet by combining functionalities of a tuner, browser, search engine, player, recorder, advertising server, message center, and premium content delivery platform. The server side software provides standardization of multiple online media formats, platforms and transmission protocols as well as various database and client service functions. The system is designed to be user friendly, and mimics traditional TV watching experience.

### BACKGROUND OF THE INVENTION

With proliferation of Internet media sources, further development of Internet Protocol Television (IPTV), exponential growth in availability of free or low cost media content, there is a need for an efficient and economical system of delivering media rich Internet content to conventional Television sets. There is also a need for the new generation of Internet based content providers to cost effectively expand their audience base.

Consumer electronics industry has produced many high-end computer/TV and Internet/TV convergence devices, which offer access to new generation entertainment environment. Users are typically required to replace existing devices by purchasing new expensive equipment and subscribe to premium services. High costs of access make these solutions attainable only to a limited audience.

Hybrid proprietary hardware-software solutions, such as TiVo, Apple TV, Netflix have made availability of movies and pre-selected shows more affordable to an average consumer. These services are typically limited to specific Web sites and have relatively small customer base due to the required purchase and installation of another set-top box, home network, additional remote control and some form of subscription. Migration from one platform to another is constrained or impossible, and a change of provider requires a purchase and installation of a completely new system.

Recent advances in media player technologies provide advanced computer users with enhanced experience in consuming a large number of television and radio broadcasts streamed to the user's workstation. The quality of these streams is typically very poor and there is no unified system of searching and navigating these internet media channels. While availability of media transmitted over the Internet will continue to grow, the distribution of such media will continue to be limited to computer users. The general public will continue to prefer watching the news, shows, movies and other programs on their television sets in a traditional on-the-couch-remote-in-hand environment.

Internet has already outgrown TV in many countries as users spend more time online. With technology, industrial, and interface improvements, all-in-one digital devices, combining functionalities of modern day TV, Internet connected personal computer based media processing units, and telephones, will become the norm. Coupled with the continued decline in the cost of bandwidth these advances make full convergence of Internet and TV a near reality.

This invention provides methods of a low cost cross-over solution to make Internet and TV broadcast media resources available to much larger audiences. The invention will advance the true convergence of Internet and Television, offer the ultimate Video-on-Demand, interactivity, such as gaming, video conferencing, shopping, voting, etc.; and dramatically increase the viewing base to cause further improvements in multimedia content quality, processing and delivery technologies.

### SUMMARY OF THE INVENTION

To address the bottleneck problems outlined above, the present invention overcomes deficiencies in the prior art by providing convergence methods, systems and software platform for a low cost solution, which is readily available to general public. The system will use the Internet access, to organize and play any media channels according to viewer preferences on a computer and/or a conventional TV set and/or any computer/Internet/TV convergence device, stationary or portable. By utilizing a remote controlled proprietary media processing software program serving as a tuner, browser, organizer and player (“Software”) in conjunction with an associated hardware configuration utilizing available consumer technologies, the system allows users to play any type of Internet media content, streamed, broadcast or stored, in a traditional TV watching environment.

The invention enhances user experience in consumption of interactive digital media content by providing a specialized media player with a user interface (“UI”) that uses a standard keyboard, keypad and/or a universal remote control as input devices. The UI is intuitive, customizable, and upgradeable. The UI is displayed on a computer monitor (if present, locally or as part of a network) and on the user's TV monitor. The UI allows the user to selectively call and hide an image of a standard keyboard, menu bars, information window, and other areas within the frameless full screen media player window. The UI includes all standard TV remote control functions, including but not limited to channel search and selection controls, and audio/video controls, as well as other functions typically present in media players. The UI will also have many system specific functions such as custom search, preferences, save/record, information and message center, subscriber services, billing, advertising, ordering and purchasing, to name a few. The UI also permits displaying executable content-related images, such as program descriptions and advertisements while viewing the main content.

The features of the present invention described herein are easier to implement than currently available techniques and are economically feasible and commercially practical since the system will use hardware components, which are already present in the user's home or office or easily obtainable at a minimum cost.

Briefly described, a method embodying aspects of the present invention includes rendering a media stream originating from the Internet, processing by the media player program installed on a client's computer or other digital data processing device, stationary or portable, local or as part of a network, and playing the media content either on that device or a TV set, which is connected to the computer. The system can be controlled either via the computer keyboard, a wireless keyboard or a universal remote control. All available media channels are organized in an easy-to-search database for consumer and easy-to-manage control panel for content provider.

In another embodiment, a method of processing media content includes rendering a media file stored on the user's computer or on a remote Web server. The media player function of the Software plays the audio visual rendering elements of the media file in a frameless full screen presentation mode. The method also includes selectively presenting a playback control UI on the display in response to user input via an input device. The playback controls, playlists or favorites, as well as other tools are viewable with the visual rendering element while maintaining the full screen presentation mode and executable in response to user's command via an input device.

In another embodiment, a method of organizing internet media channels provides for the indexation, registration and user friendly presentation and display of desired content channels. Server side and client side software codes will allow users to easily navigate in the rapidly growing universe of internet media and quickly find the requested channel.

In yet another embodiment of the invention, a method of delivering media content includes rendering media files by a remote server, which may represent messages, announcements and advertisements, and playing the content on the user's entertainment system.

The Software, which can be further developed through open programming interface (API), will provide media companies and content providers with unlimited opportunities to use actionable viewer analytics and customize programming, advertizing and monetization.

Computer-readable media having computer-executable instructions for performing methods of processing media content embody further aspects of the invention.

Alternatively, the invention may comprise various other methods and apparatuses.

Other features will be in part apparent and in part pointed out hereinafter.

### BRIEF DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a block and a signal flow diagram for a receiver/transmitter system including a computer or a digital data processing device, portable or stationary, with an Internet connection and a mass storage device, built-in or external (“Computer with Internet connection and storage device”); a Wireless Transmitter/Receiver connected to the Computer; a digital TV set with a Wireless Receiver, attached or built in; an optional Wireless Receiver/Transmitter Extender/Signal Amplifier; and a user input device, such as Remote Control programmable to operate the Computer and TV.

FIG. 2 is a block and a signal flow diagram illustrating connections between hardware components, some of which can be combined in a computer/TV/Internet convergence device.

FIG. 3 is a block and signal flow diagram illustrating connections between Computer Software, Web Server, Broadcast A/V Source and the Monitor.

FIG. 4 is a block diagram of an exemplary display along with a layout of various functionalities, controlled by the inventors' media processing Software.

FIG. 5 is a listing of different menu functions available to the user.

FIG. 6 is an operation flow diagram illustrating user's interactions with hardware components of the invention.

FIG. 7 is a diagram of claims under the present invention.

### DETAILED DESCRIPTION OF THE INVENTION

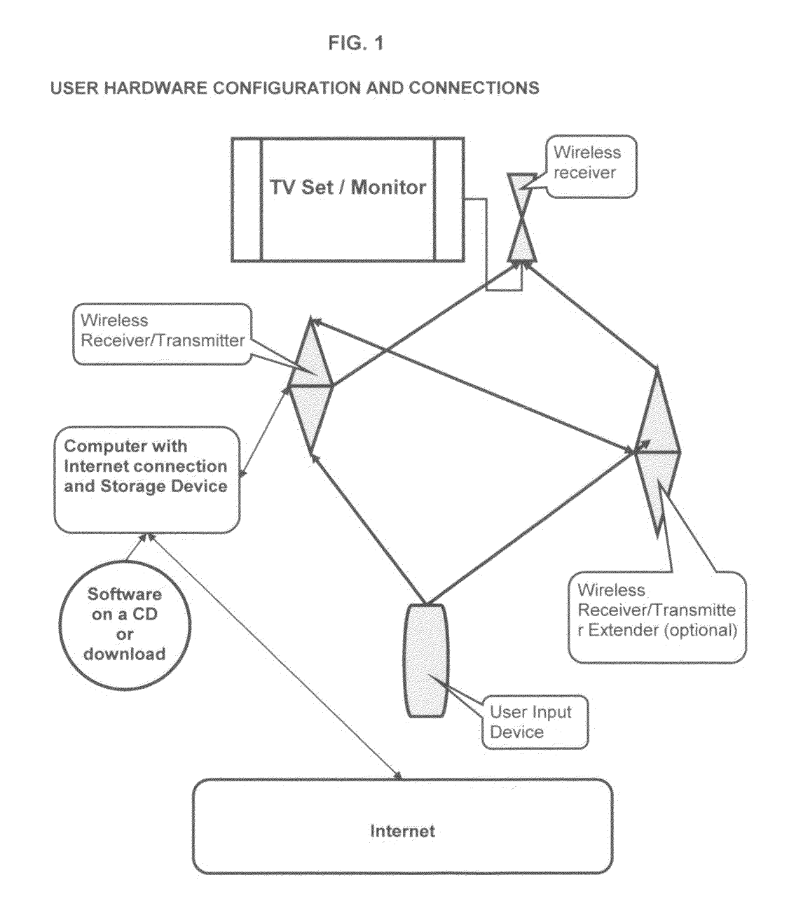

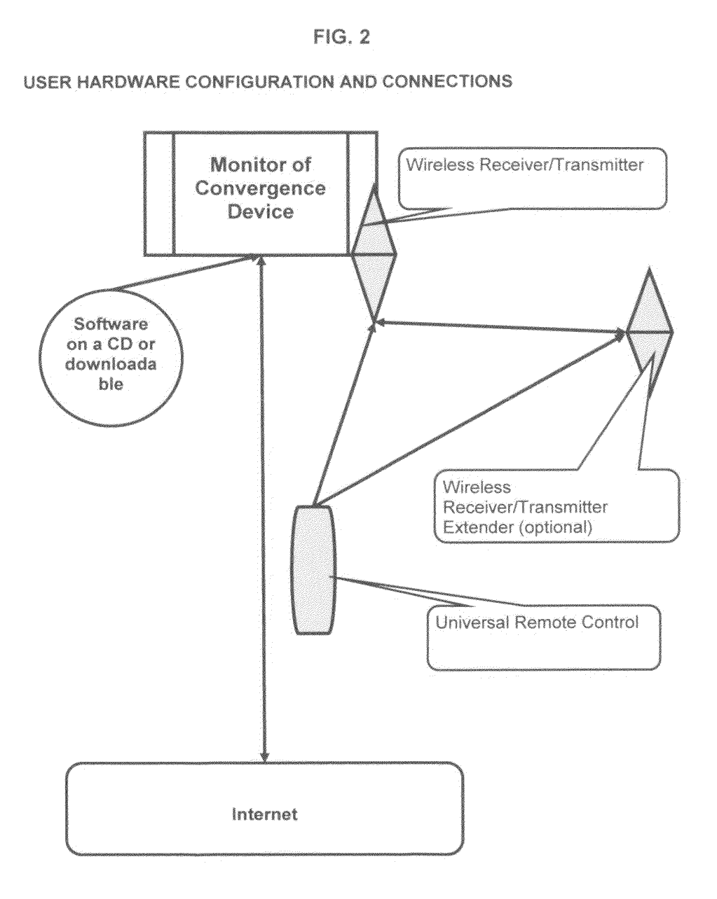

The following detailed description, which references and incorporates FIGS. 1-7, describes and illustrates specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

Referring to the appended drawings, FIGS. 1, 2 and 3 illustrate an exemplary network environment in which the present invention can be implemented.

The hardware part of the system can be assembled and configured by the client using any convergence device or other available consumer technologies at a marginal cost. The system has a client computer or other data processing device, stationary or portable, local or as part of a LAN (“Computer”), coupled to a data communication network of server computers. In this example, the network is the Internet (or the World Wide Web). However, the present invention can be applied to any data communication network and use any available Universal Plug and Play device. The system can use any type of monitors (more than one can be used at the same time), such as a computer, TV, A/V entertainment system or any convergence device (“Monitor”); a set of receivers and transmitters, capable of wirelessly connecting appliances; and a user input device, such as a programmable remote control, keyboard, keypad, etc., wired or wireless (“Input Device”), to activate different menus and tools of the user interface (“UI”) on the Monitor.

To further enhance the operation of the system, a mass media storage device (“Storage Device”) can be used to store the compressed digital video data streams and other media content. This can be the hard drive of the Computer or a separate storage device for later viewing connected to or built into the Computer. Any personal video recorder (PVR) or digital video recorder (DVR) systems can be incorporated in the hardware architecture. These systems are typically used to store shows or movies so that they can be viewed at a later time and provide convenient mechanisms for storing digital video streams. It is further noted that the outputs from the storage device(s) can also be used for picture-in-picture (PiP), split screen and other functionalities, if desired by the user. The storage system can save a portion of (e.g. for instant replay) or all of the compressed data streams for the selected channels.

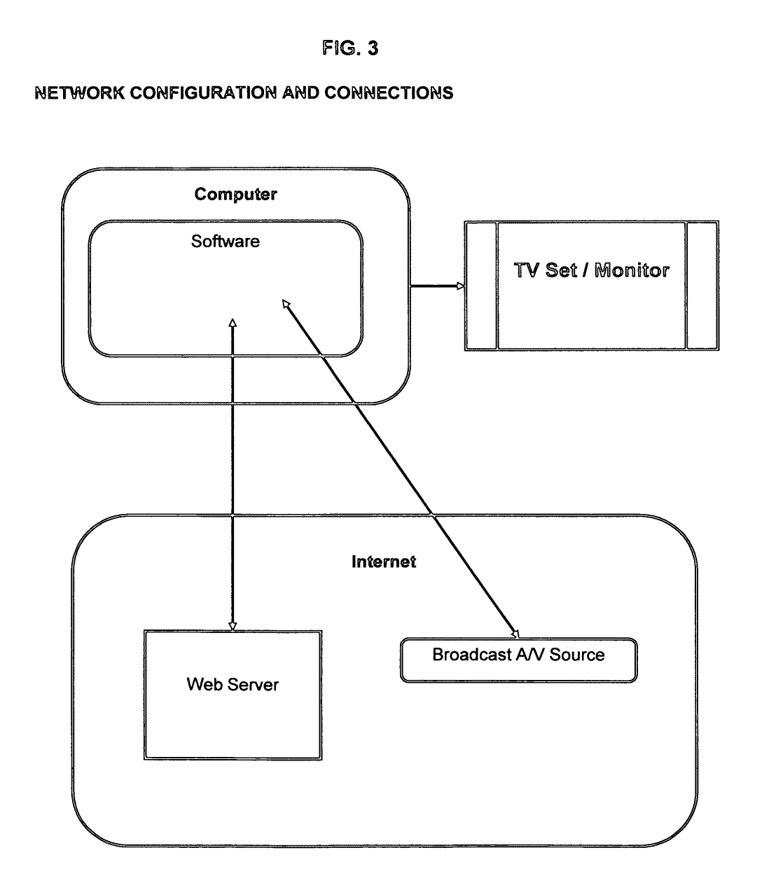

FIG. 3 further illustrates a typical data flow. The Software application, described herein (“Software”), installed on the client's Computer communicates with the Web Server(s) and media content sources (“MC Sources” or “Broadcast ANV Sources”) and outputs the media content to the Monitor. Databases and other software applications reside on the Web Server to provide multi-channel programnuing source, downloading, media access, upgrading, advertising and other associated services to the client. Web Server(s) and client Computer(s) communicate in the illustrated embodiment using the hypertext transfer protocol (HTTP), a protocol commonly used on the Internet to exchange information. Various features of the described systems and methods include a set of databases, client side executable code, and a series of server side processes that provide for querying and maintaining the databases and standardization of formats and transmission protocols.

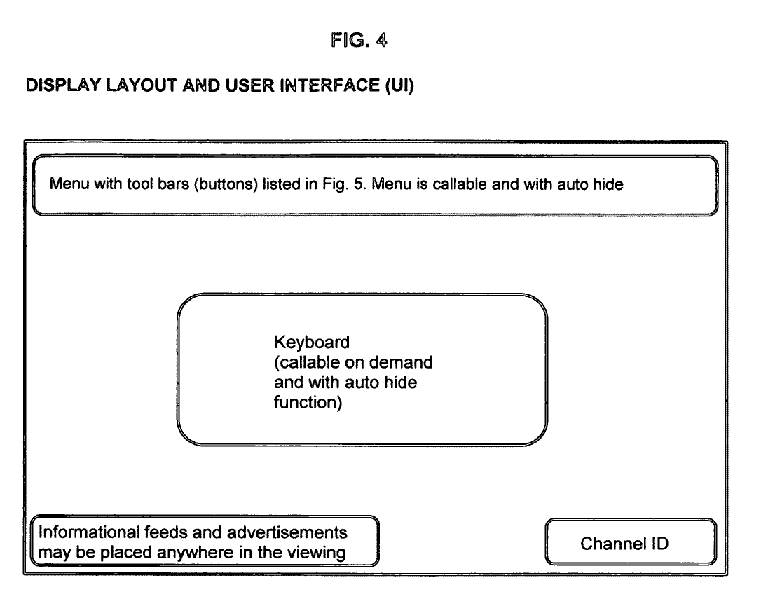

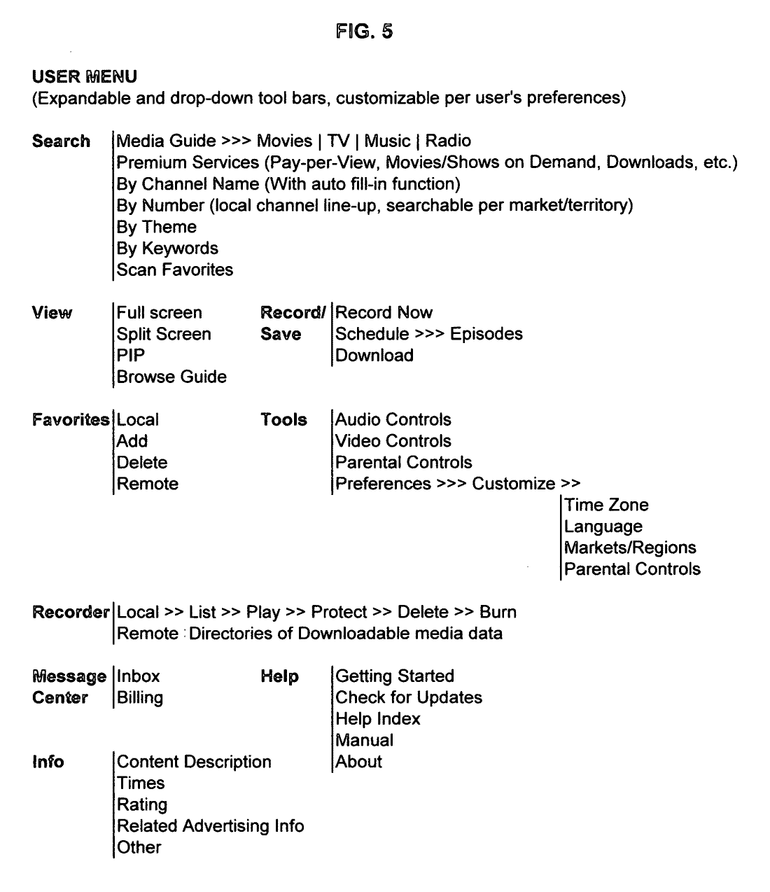

The invention provides software routines that, when executed by a computer, render media content and retrieve, store, and display related information via the user interface (“UI”). Referring further to FIG. 4, the user installs the Software onto the Computer from a CD or via a direct download from a Web Server. During the installation the Software will automatically locate, identify and configure all available hardware components. Client's Computer then connects to a Web Server to obtain information relevant to the selected channel. All available programming information is displayed in the UI as outlined in FIG. 5. The Software then establishes a connection with the URL, associated with the selected channel, to obtain a direct access to the source of the requested digital media file, stored on, streamed or in any other way transmitted from an Internet or other network server. The media player component of the Software consequently plays the Media Content transmitted from the source URL.

The client's Computer can also access local media files, such as ones residing on a compact disc (CD), digital versatile disc (DVD), or other available computer mass storage media.

It is noted that the digital media signal spectrum can be any signal originating from a remote URL. The inventors' Software will be upgraded periodically to include the state-of-the-art digital signal compression technologies. It is expected, that availability of the digital media transmitted over the Internet will become increasingly ubiquitous and the quality of these signals will improve dramatically so that the consumer will not be able to tell the difference between the content originating from the Internet and the one available from television networks.

The inventors' Software installed on the client Computer executes browser functions to access databases on the Web Server and the requested media content on the Broadcast ANV Source; player functions to render and play the requested media file; and UI functions on the Monitor in a full screen frameless/skinless presentation mode. The invention calls for selectively presenting menus and controls on the display in response to user input via an Input Device. In this instance, the user is able to view the control UI simultaneously with the visual rendering element while maintaining the full screen presentation mode (FIG. 4).

In this embodiment, the invention alpha-blends controls and other data obtainable from/or displayed by a Web Server directly onto the visual image source. Alpha-blending allows for a translucent effect where the user clearly sees controls and other data but can still view the underlying visual image source through the controls. Those skilled in the art are familiar with alpha-blending and other similar techniques by which images can be layered whereas images contained in the top layers are transparent to show the content of the underlying layers (FIG. 4).

The present invention involves innovative techniques, systems, and methods that enable media content, related information and advertising to be packaged and delivered in a manner that can greatly enhance the user experience.

One aspect of the present invention is a method, system and software code for organizing Internet media content into alphanumeric channels. The method includes registration of each Internet broadcast in a database which will contain its details such as title, description, rating, owner, and the like, along with its web URL. Extended metadata may include reviews, related content, where to buy items appearing in the program, upcoming events, sales information, links to other related experiences including purchase opportunities, and the like. The system assigns a unique ID number to each Internet broadcast channel registered in its database. The channel numbers are assigned based on a theme, with the initial one or more characters representing that theme, followed by the unique identifier of the channel. For example, a number assigned to a sports broadcast channel is 111. The first 2 characters (“11”) represent a theme called “sports”, and the final digit (“1”) is the actual channel number of that broadcast. Alternatively, a family comedy channel may have F5123 as the ID. “F” may stand for “Family”, “5”—“Comedy”, and “123” is the actual channel number within this category.

It is to be understood that the above two examples are simply two ways that a physical ID can be generated for a media channel. The channel assignment serves multiple purposes, including the capability of having unlimited number of channels and the ability to assign easier-to-remember IDs to more popular channels and etc.

Another aspect of the present invention is a method, system and software codes, client side and server side, to present highly relevant information-rich content and interaction capabilities for enhanced user experience. Media content provider may selectively embody additional data into the media stream so it may be callable into the UI by user's input, such as an information button or a hot key on the user's Input Device. This additional content may represent advertising, including interactive or clickable links to other service providers.

Yet another aspect of the present invention is a method, system and software codes, client side and server side, to present on the UI highly relevant advertising content and interaction capabilities, such as voting or other user feedback, provided by the Web Server. Clickable images, audio, video, captions, scrolling ticker or other content which may represent informational feeds or advertisements can be displayed on the screen at any time based on the information obtained from a remote URL. Statistics on use of the system including information voluntarily submitted by users can be sent to a remote URL at any time or at scheduled intervals.

Yet another aspect of the present invention is a method, system and software codes, client side and server side, which allow users to select different geographical areas to navigate and view local TV channels and radio stations available in a particular area or market. Internet only channels can also be selected from a specially designated alphanumeric channel range consisting of pre-registered Internet broadcasts that match the broadcast's URL with a unique channel ID. By using a search function or manually entering a URL, users can access any audio or video content from the Internet both stored and live.

The Software will also enable the user to record any media content in advance or in real time. Selected programs can be ordered on a pay-per-view/view-on-demand basis.

All such presentations in the UI may be selectively done in an alpha-blending mode, solid color screen mode, picture-in-picture (“PiP”) mode and the like.

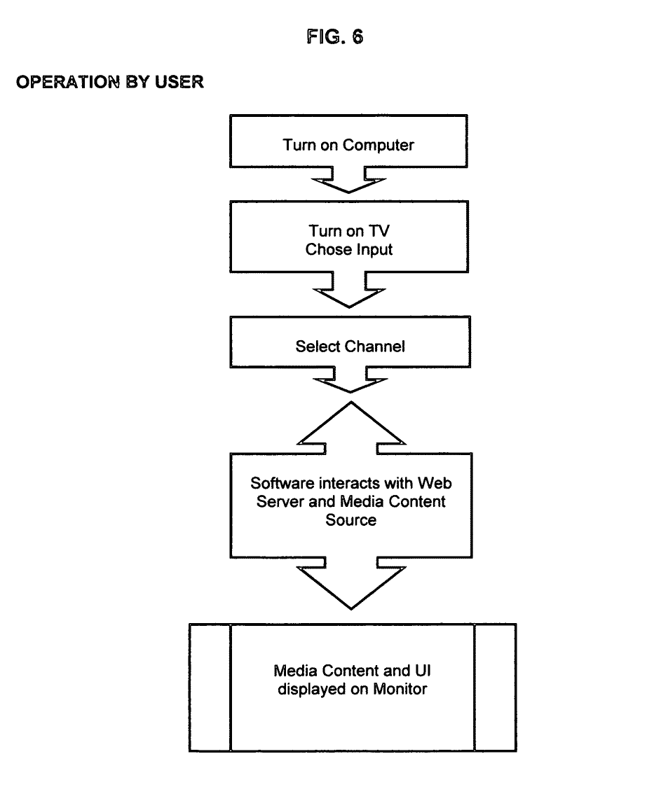

FIG. 6 appended hereto, illustrates the operation routines of the invention:

1) Turn on the network Computer with the pre-installed Software (it is preferred to leave said computer running at all times to skip this step).
2) Turn on the television set, and set it to the designated Audio/Video input channel (it is preferred to always leave the television set tuned to this input channel to skip this step).
3) Using an Input Device programmed to operate with the hardware component of the invention, select a channel by its unique identifier or by pressing the channel up or down button on the remote.
4) After a channel is selected, the Software connects to Web Server to access the main database containing all registered channels, and retrieves all available information about the channel including but not limited to name, ratings, program schedule, and the URL of the actual Broadcast ANV Source on the Internet.
5) A connection to the Broadcast ANV Source is then made by the media player component of the Software, and that broadcast is displayed on the television screen.
6) During the broadcast, the Software will make intermittent connections to the Web Server to retrieve additional information, such as advertising data, programming schedule, ratings, reviews, etc., and transmit user specific data such as channel being watched, length of time the channel is being watched, along with other user action inspired data to the Web Server.

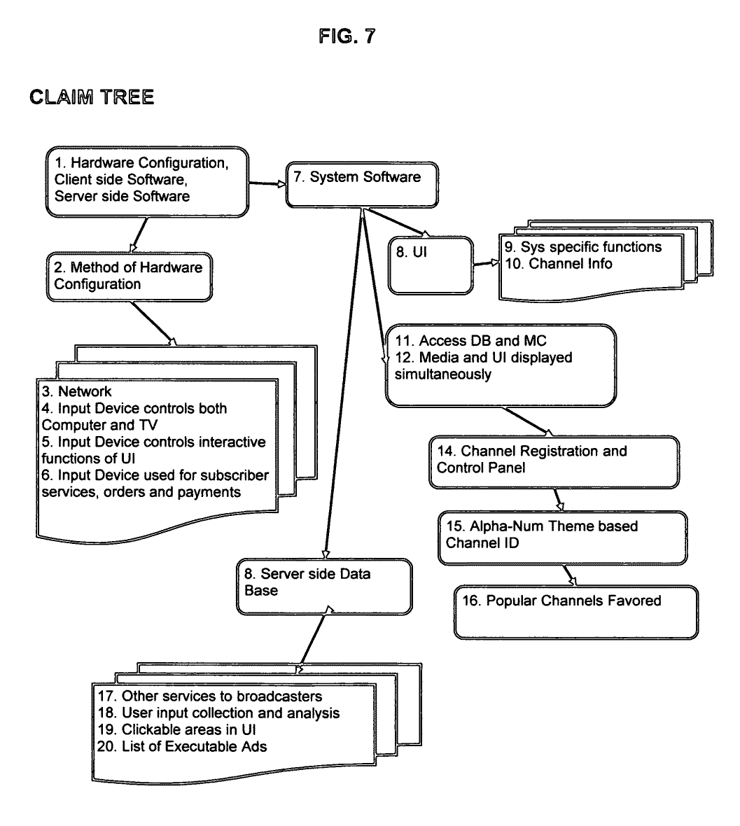

FIG. 7 appended hereto, illustrates the claim tree of the invention.

As various changes could be made in the above constructions, implementations, configurations, architectures and methods without departing from the scope of the invention, it is intended that all matter contained in the above descriptions and shown in the accompanying drawings shall be interpreted as illustrative and not in a limiting sense. Equivalent elements may be substituted for those illustrated and described herein and certain features of the invention may be utilized independently of the use of other features, all as would be apparent to one skilled in the art after having the benefit of this description of the invention.

What is claimed is:

1. A method of assembling, activating and operating a software-based convergence system, which includes a client end hardware component configuration; a client installable and executable media organizing and rendering program; a server end data base and data processing program for delivering media content originating from a computer network to a client's television set.
A method of claim 1, wherein the client end hardware component configuration is performed by the client, using existing consumer electronics technologies, said configuration comprising a client computer or other data processing device, stationary or portable, stand alone or part of a local area network (“Computer”), coupled to a data communication network of server computers; numerous types of monitors (more than one can be used at the same time), such as a computer, TV, A/V entertainment system or any convergence device (“Monitor”); a set of receivers and transmitters, capable of wirelessly connecting appliances; and a user input device, such as a programmable remote control, keyboard, keypad, etc., wired or wireless (“Input Device”), to activate different menus and tools of the user interface (“UI”) and execute various functions of the client end software program (“Software”).
A method of claim 2 wherein a data communication network of server computers used by the system can be a local network or the Internet.
The method of claim 2 wherein the Input Device wirelessly controls both Computer and Monitor to execute software functions and display UI.
The method of claim 2 wherein the Input Device is used to selectively call, hide and execute all menus, tools, clickable areas and other interactive functions presented by the UI.
The method of claim 2 wherein the Input Device is used to subscribe, unsubscribe, pay bills, order services, make purchases and provide other input and feedback.
A system of claim 1 for processing media content comprising a computer executable software application (“Software”) for accessing a remote data base of registered channel listings, retrieving the URL of the media source, rendering the requested media file, playing the media content and for presenting a user interface (UI) associated with the Software on the client's computer and/or TV Monitor.
The method of claim 7 wherein the Software creates and displays a particular UI, which allows the user to interact with the system and execute various controls.
The system of claim 8 wherein, the user through the UI can, in addition to typical media player and TV controls, execute the Software specific commands such as search, organize, interact with informational and advertising feeds, and provide feedback.
The system and methods of claim 8 wherein the Software, responding to the user input, presents in the UI channel specific information, which includes without limitations the program name, episode number, short description, and any other content related information the broadcaster may provide; start and end times, reviews, ratings, and any other pertinent metadata.
The method of claim 7 wherein the Software, responding to the user input, connects to a Web Server to access a data base of registered network multimedia channels, retrieves the channel specific content information, which is presented on the UI, and connects the Computer to the URL of the media source associated with the selected channel, thus implementing global delivery of the channel's programming.
The method of claim 7 wherein the Software renders the media content and plays/outputs audio and video signals to client's Monitor simultaneously with callable UI, such UI can be displayed selectively in an alpha-blended, solid background, or picture-in-picture mode.
The method of claim 7 wherein the remote server side data base and backend infrastructure is programmed to service various inputs from client side UI and media content providers as well as direct connection to the streaming broadcasts and download services.
The method of claim 13 wherein the remote data base is programmed to provide registration and control panel services to media channel owners.
The method of claim 14 wherein the alphanumeric registration system assigns unique alphanumeric ID to each registered channel, whereas the initial one or more characters assign a channel to a theme-based category and the following unlimited numbers of characters further identify the channel to create a unique alpha-numeric channel ID.
The method of claim 15 wherein the alpha-numeric registration system favors more popular channels in choosing the physical ID.
The system and methods of claim 13 wherein server side software codes are used to provide registration, data processing, advertising, statistics, viewer analytics, reporting and other services to broadcasters.
The method of claim 13 wherein server side software codes are used to collect, process and report users' input to a remote server; such statistical data may include any collectable non-private data, which will allow to determine, among other possible parameters, the number of users, viewers, click throughs, analyze users' channel changing activities, various historical statistics, popularity and rankings of channels, programs, content producers, broadcasters, etc.
The system and methods of claim 13 wherein the Software, responding to the user input or a remote server command, presents user clickable areas in the UI, which may represent advertising, connects the system to the corresponding URL, and presents the requested content in a full screen or PIP mode as selected by the client.
The system and methods of claim 13 wherein the Software, responding to the user input, presents a list of products and services advertised on a particular channel, such list may contain links to products and service providers and offers to place an order.
